(19) United States
(12) Patent Application Publication
(10) Pub. No.: US 2009/0008062 A1
(43) Pub. Date: Jan. 8, 2009

(54) Heat Transport Medium and Heating or Cooling System with the Medium

(76) Inventors: Ernst Hammel, Wien (DE); Xinhe Tang, Wien (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/087,335

(22) PCT Filed: Nov. 30, 2006
(86) PCT No.: PCT/IB2006/003769

§ 371 Date: Jul. 2, 2008

(30) Foreign Application Priority Data
Jan. 9, 2006 (DE) 102006001335.2

(51) Int. Cl. F28D 15/00; C09K 5/10

(52) U.S. Cl. 165/104.19; 252/73

(57) ABSTRACT

The invention relates to a heat transport medium which is made up of a liquid base component in the form of water and at least one additive from polyvinyl alcohol (PVA) and a nanofiber material.

### BACKGROUND OF THE INVENTION

The invention relates to a heat-transporting medium and heating or cooling system with the medium.

The use of liquid heat-transporting media, in particular in active cooling systems, is known in the art. The existing art includes the use of heat-transporting media that contain water as a base component, possibly with a further additive, for example with an antifreeze or corrosion protection additive.

Also known in the existing art are suspensions of water and nanofibers, e.g. for use as a coolant, in which the addition of nanofibers reduces the thermal resistance of the heat-transporting medium and therefore significantly improves the heat transfer between the heat-transporting medium and a cooling function element or a function element to be cooled, for example an external cooler or heat exchanger or a component to be cooled. The disadvantage of such heat-transporting media, however, is that they are very unstable, i.e. the nanofiber material tends to precipitate or settle or clump.

It is an object of the invention is to present a liquid heat-transporting medium that prevents the disadvantages of existing heat-transporting media with a nanofiber basis while maintaining low thermal resistance.

### SUMMARY OF THE INVENTION

In its simplest embodiment, the heat-transporting medium according to the invention, is made up of the base component of water with the sufficient addition of a polyvinyl alcohol (hereinafter PVA). In a preferred embodiment, the heat-transporting medium, according to the invention, contains PVA and nanofiber material especially with a carbon base as an additive to the base component. Preferably the nanofiber material is first pre-treated with a concentrated solution of PVA and a suitable solvent, for example water, and is provided with PVA in this manner, namely by mixing it with the PVA solution. The nanofiber material pre-treated in this manner is then added to the base component, which includes water and a further component.

Nanofiber material according to the invention refers to nanotubes and/or nanofibers made of a material with high thermal conductivity, in particular nanotubes and/or nanofibers with a carbon base.

### BRIEF DESCRIPTION OF THE DRAWINGS

The invention is described below in detail based on exemplary embodiments with reference to the drawings, wherein:

FIG. 1 is a very schematic depiction of an array for measuring the thermal resistance of a liquid heat-transporting medium;

FIG. 2 shows the temperature of the heater and the cooler of the measuring array of FIG. 1 based on the concentration of the carbon nanofiber material in the liquid heat-transporting medium or it base component;

FIG. 3 is a graph showing the measured thermal resistance Rth based on the content of carbon nanofiber material, also in comparison with water without an additive and with water with a PVA additive as the heat-transporting medium; and

FIG. 4 is an example of the use of the liquid heat-transporting medium according to the invention as a coolant.

### DETAILED DESCRIPTION OF THE INVENTION

The heat-transporting medium is made up of a suspension of water as a base component and nanofiber material, which in this embodiment of the invention is made up of at least primarily of nanotubes and/or nanofibers with a carbon base and which were pre-treated with a polyvinyl alcohol (PVA) to stabilize the suspension prior to mixing with the base component water. This pre-treatment is achieved, for example, by mixing the nanofiber material in a solution containing a high concentration of PVA, for example in a solution with a PVA content of at least 5 percent by weight in relation to the total weight of the solution or in a saturated PVA solution. Water is used as the solvent, for example.

The nanofiber material thus pre-treated or furnished with PVA is then mixed with a sufficient quantity of water into the aqueous suspension forming the heat-transporting medium, the content of pre-treated nanofiber material in the heat-transporting medium preferably being less than 15-20 percent by weight in relation to the total weight of the heat-transporting medium, in order to ensure optimum flow behavior for the medium, as required for example in the event of use as a cooler, heat exchanger or other circulating coolant. The pre-treatment with PVA makes the nanofiber material easily dispersible in water, so that the heat-transporting medium forms a stable suspension.

The pre-treatment of the nanofiber material with PVA or the application of PVA to the nanofiber material also achieves a lubricating or sliding effect, namely for example with the advantage that the heat-transporting medium flows with low impact through channels, chambers, etc., effectively preventing abrasion to the inner surfaces especially of narrow channels, chambers, etc. The pre-treatment with PVA also prevents clumping of the nanofiber material in the heat-transporting medium.

Suitable nanofibers for the nanofiber material are, for example, nanofibers with the designation “Pyrograf III” or “HTF 150 FF-HHT” offered by Electrovac AG, A-3400 Klosterneuburg, Austria. Other nanofibers than can be used as nanofiber material in the invention, also available from Electrovac AG, A-3400 Klosterneuburg, Austria, are listed in the following table.

TABLE 1

| | | N2 | | | | | | |
|---|---|---|---|---|---|---|---|---|
| | Nano- | specific | | | Thermal | Electrical | Metal | |
| | fiber | surface | Diameter | Length | conductivity | resistance | content | Density |
| Nanofiber | type | [m2/g] | [nm] | [μm] | [W/mK] | [Ohm/cm] | [wt. %] | [g/cm3] |
| HTF150FF | AGF | 10-20 | 100-200 | >10 | >600 | <10⁻³ | <0.5 | 1.95 |
| HTF150FF | PSF | 20-30 | 100-200 | >10 | >600 | <10⁻³ | <0.5 | 1.95 |
| HTF150FF | LHT | 15-20 | 100-200 | >10 | >600 | <10⁻³ | <0.5 | >1.95 |
| HTF150FF | HHT | 15-25 | 100-200 | >10 | >600 | <10⁻³ | <0.01 | >1.95 |
| HTF110FF | AGF | 53 | 70-150 | >10 | >600 | <10⁻³ | <0.5 | 1.95 |
| HTF110FF | PSF | 50-60 | 70-150 | >10 | >600 | <10⁻³ | <0.5 | 1.95 |
| KTF110FF | LHT | 43 | 70-150 | >10 | >600 | <10⁻³ | <0.5 | >1.95 |
| HTF110FF | HHT | 41 | 70-150 | >10 | >600 | <10⁻³ | <0.01 | >1.95 |
| ÉNF100AÀ | HTE | 80-100 | 80-150 | >10 | >600 | <10⁻³ | <0.5 | 1.98 |
| ENF100AA | GFE | >50 | 80-150 | >10 | >600 | <10⁻³ | <0.01 | 2.17 |

Nanofiber type:
ACF as grown
PSF pyrolytic stripped carbon nanofiber
LHT heated at~1000° C.
HHT heated at~3,000° C.
HTE heated at~1,000° C. with EVAC
GFE heated at~3,000° C. with EVAC

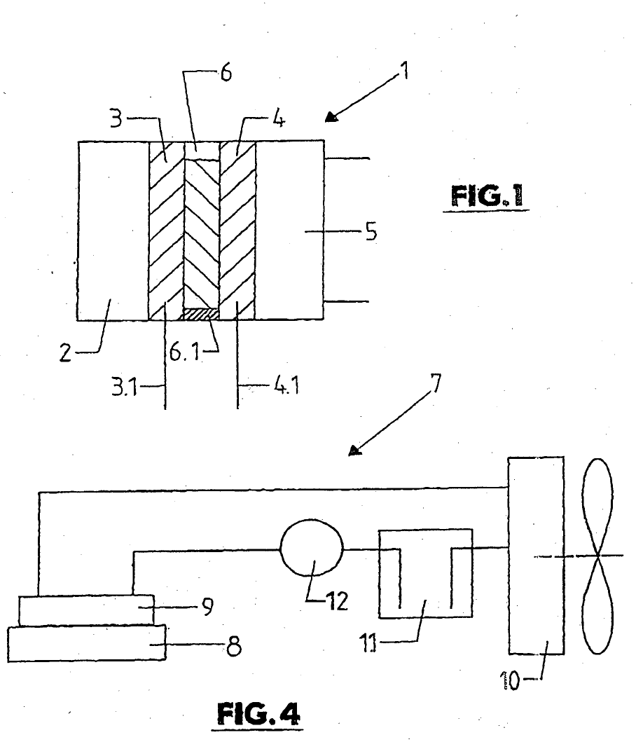

In FIG. 1, 1 is a measuring array, which is suitable for measuring the thermal resistance Rth of a liquid heat-transporting medium and which consists essentially of an electric heater 2 on a surface side of a first plate 3 made of copper, of a second plate 4 also made of copper and of a cooler 5 provided on a surface side of said plate. The cooler is designed for example as a passive cooler, i.e. cooled by the ambient air, or as an active cooler, i.e. circulated by a coolant, namely water. The plates 3 and 4 are connected two-dimensionally with the heating element 2 or the cooler 5 in a thermally optimum manner, for example using a thermal conductive paste with known properties. Further, the plates 3 and 4 are provided with a temperature sensor 3.1 and 4.1 for measuring the temperature T1 of the plate 3 and the temperature T2 of the plate 4. Between the facing sides of the plates 3 and 4 there is a measuring gap 6, which during measuring is completely filled by the heat-transporting medium to be measured and is bounded on the side by a corresponding seal 6.1, which prevents undesired leaking of the heat-transporting medium from the measuring gap 6 and also defines the width of the measuring gap 6 or the distance between the two plates 3 and 4. In the depicted embodiment the width of the measuring gap is approximately 100 μm.

The thermal resistance is defined as follows:

Rth(°K/W)−(T1−T2)/output of the heat element 2 in W

The measuring array 1 was used to measure the thermal resistance of various samples containing the nanofiber material pre-treated with PVA in various concentrations, namely 0.5, 1.0, 2.0, 4.0 and 8.0 percent by weight respectively in relation to the total weight or total mass of the heat-transporting medium.

FIG. 2 shows the measured temperatures T1 and T2. While temperature T2 of the measuring plate 4 or of the cooler 5 is essentially constant, the temperature of the plate 3 or of the heating element 2 decreases as the concentration of nanofiber material in the heat-transporting medium increases, which means that the thermal resistance Rth decreases as the nanofiber material content increases and inversely, the thermal conductivity of the material increases as the nanofiber material content increases.

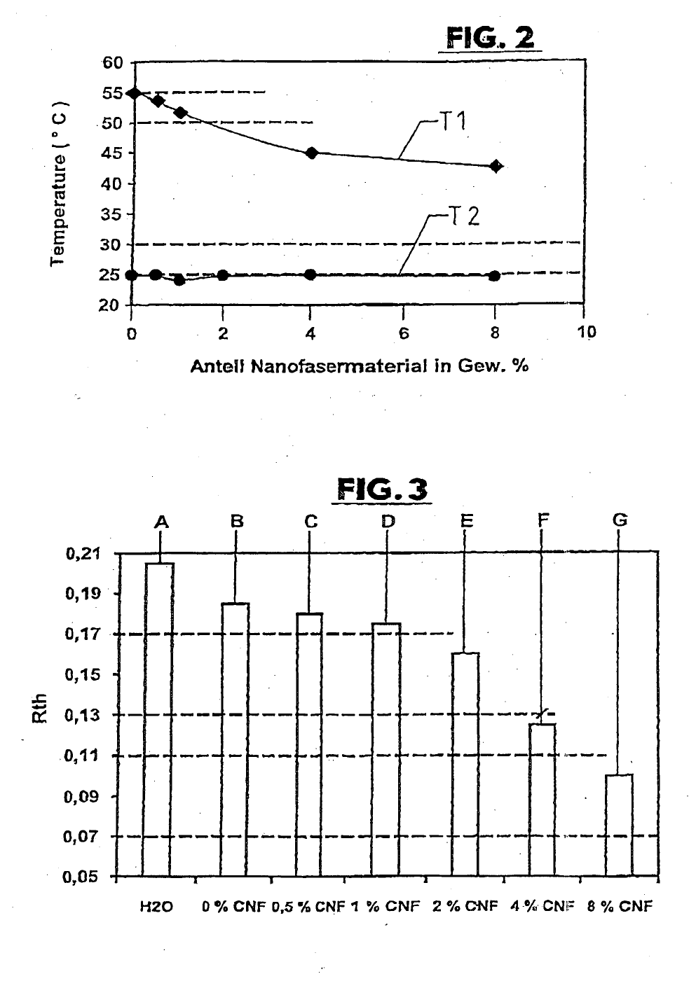

FIG. 3 shows the respective thermal resistance resulting from the temperature difference T1 and T2, namely for various samples A-G, said samples having the following composition:
Sample A: water without further additives
Sample B: water with PVA in a concentration of approximately 5 percent by weight
Sample C: water with 0.5 percent by weight nanofiber material pre-treated with PVA
Sample D: water with 1.0 percent by weight nanofiber material pre-treated with PVA
Sample E: water with 2.0 percent by weight nanofiber material pre-treated with PVA
Sample F: water with 4.0 percent by weight nanofiber material pre-treated with PVA
Sample G: water with 8 percent by weight nanofiber material pre-treated with PVA in relation to the total weight of the respective sample.

Even a content of 0.5 percent by weight nanofiber material results in a reduction of the thermal resistance by approximately 12% as compared with pure water. A content of 4 percent by weight nanofiber material reduces the thermal resistance by approximately 38% as compared with water.

The use of PVA for the pre-treatment of the nanofiber material or for stabilizing the liquid heat-transporting medium also offers the advantage that PVA is toxicologically safe and at least partially biologically degradable and therefore environmentally safe.

FIG. 4 shows a schematic depiction of a cooling system, generally designated 7 in this figure, for cooling an electric component, for example a processor 8 of a computer. The heat-transporting medium according to the invention is used as a coolant in this cooling system 7. The cooling system consists in the known manner of a component cooler 9 that is mounted on the processor 8 and can be circulated by the coolant and of an external cooler 10, with a corresponding fan, which (cooler) is provided on the outside of the housing of the computer and can likewise be circulated by the cooling medium. The cooling system 7 further comprises at least one tank or reservoir 11 for the coolant and a circulating pump 12, which is provided together with the cooler 9 and the external cooler 10 in a closed coolant circuit.

Due to the reduction of the thermal resistance of the heat-transporting medium and due to the resulting improved heat transfer from the component cooler 9 to the heat-transporting medium or cooling medium, the performance of the cooling system 7, i.e. the quantity of heat dissipated from the processor 8 per unit of time, can be increased significantly.

The invention was described above based on exemplary embodiments. It goes without saying that numerous modifications and variations are possible without abandoning the underlying inventive idea on which the invention is based.

### REFERENCE LIST

1 measuring array
2 heat element
3, 4 measuring plate
3.1, 4.1 temperature sensor
5 cooler
6 measuring gap
6.1 seal
7 cooling circuit
6 electric component, for example processor
9 component cooler
10 external cooler
11 reservoir for coolant
12 circulating pump

What is claimed is:

1. A heat transporting medium comprising a liquid matrix or base component comprising at least partially of water and of at least one additive, wherein the additive is at least one polyvinyl alcohol.

2. The heat-transporting medium according to claim 1, wherein the base component contains polyvinyl alcohol and a nanofiber material as an additive.

3. The heat-transporting medium according to claim 1, wherein the at least one additive is made of a nanofiber material that is pre-treated or provided with a polyvinyl alcohol.

4. The heat-transporting medium according to claim 3, wherein the nanofiber material is pre-treated by mixing with a pre-treatment solution containing a polyvinyl alcohol.

5. The heat-transporting medium according to claim 4, wherein the pre-treatment solution contains 5 percent by weight polyvinyl alcohol.

6. The heat-transporting medium according to claim 4, wherein the pre-treatment solution is a saturated polyvinyl alcohol solution.

7. The heat-transporting medium according to claim 2, wherein the nanofiber material contains nanofibers, nanotubes, or a combination of nanofibers and nanotubes.

8. The heat-transporting medium according to claim 2, wherein the nanofiber material has a carbon base.

9. The heat-transporting medium according to claim 2, wherein the liquid base component contains a maximum of 15 percent by weight nanofiber material in relation to a total weight of the heat-transporting medium, the nanofiber material that is pre-treated with polyvinyl alcohol.

10. The heat-transporting medium according to claim 2, wherein the base component contains 0.5 percent by weight nanofiber material in relation to the total weight.

11. The heat-transporting medium according to any claim 2, wherein the base component contains 1.0 percent by weight nanofiber material in relation to the total weight.

12. The heat-transporting medium according to claim 2, wherein the base component contains 2.0 percent by weight nanofiber material in relation to the total weight.

13. The heat-transporting medium according to claim 2, wherein the base component contains 4.0 percent by weight nanofiber material in relation to the total weight.

14. The heat-transporting medium according to claim 2, wherein the base component contains 8.0 percent by weight nanofiber material in relation to the total weight.

15. (canceled)

16. (canceled)

17. The heat-transporting medium according to claim 1, wherein the base component contains polyvinyl alcohol and nanofiber material.

18. The heat-transporting medium according to claim 1, whereby the medium is used as a coolant in a cooling system with at least one internal cooler or heat exchanger circulated by the heat-transporting medium and at least one external cooler circulated by the heat-transporting medium.

19. A heating or cooling system with at least one heat exchanger or cooler circulated by a heat-transporting medium, whereby the heat-transporting medium is a medium according to claim 1.
